(19) United States
(12) Patent Application Publication
(10) Pub. No.: US 2019/0094858 A1
(43) Pub. Date: Mar. 28, 2019

(54) Parking Location Prediction

(71) Applicant: Uber Technologies, Inc., San Francisco, CA (US)

(72) Inventors: Vladan Radosavljevic, Pittsburgh, PA (US); Jeff Schneider, Pittsburgh, PA (US); Alexander Edward Chao, Oakland, CA (US)

(21) Appl. No.: 15/789,425

(22) Filed: Oct. 20, 2017

Related U.S. Application Data
(60) Provisional application No. 62/562,866, filed on Sep. 25, 2017.

(51) Int. Cl. G05D 1/00; G05D 1/02; G06N 3/04; G06N 3/08

(52) U.S. Cl. CPC G05D 1/0088; G06N 3/08; G06N 3/04; G05D 1/0212

(57) ABSTRACT

A method for predicting one or more parking locations includes receiving feature map data associated with a feature map, the feature map comprises a plurality of elements of a matrix, each element of the matrix comprises the feature map data, and the feature map data is associated with one or more features of a road. The method includes processing the feature map data to produce artificial neuron data associated with one or more artificial neurons of one or more convolution layers. The method includes generating a prediction score for each element of the feature map based on the artificial neuron data, wherein the prediction score comprises a prediction of whether each element of the feature map comprises a parking location. The method includes outputting map data associated with a map, the map data is based on the one or more prediction scores associated with each element of the feature map.

### CROSS REFERENCE TO RELATED APPLICATION

This application claims the benefit of U.S. Provisional Application No. 62/562,866, filed Sep. 25, 2017, the entire disclosure of which is hereby incorporated by reference in its entirety.

### BACKGROUND

An autonomous vehicle (e.g., a driverless car, a driverless auto, a self-driving car, a robotic car, etc.) is a vehicle that is capable of sensing an environment of the vehicle and traveling (e.g., navigating, moving, etc.) in the environment without manual input from an individual. An autonomous vehicle uses a variety of techniques to detect the environment of the autonomous vehicle, such as radar, laser light, Global Positioning System (GPS), odometry, and/or computer vision. In some instances, an autonomous vehicle uses a control system to interpret information received from one or more sensors, to identify a route for traveling, to identify an obstacle in a route, and to identify relevant traffic signs associated with a route.

### SUMMARY

According to some non-limiting embodiments or aspects, provided is a method for predicting one or more parking locations, comprising: receiving, with a computing system comprising one or more processors, feature map data associated with a feature map, wherein the feature map comprises a plurality of elements of a matrix, wherein each element of the matrix comprises the feature map data, wherein the feature map data is associated with one or more features of a road; processing, with the computer system, the feature map data to produce artificial neuron data associated with one or more artificial neurons of one or more convolution layers; generating, with the computer system, a prediction score for each element of the feature map based on the artificial neuron data, wherein the prediction score comprises a prediction of whether each element of the feature map comprises a parking location; and outputting, with the computer system, map data associated with a map, wherein the map data is based on the one or more prediction scores associated with each element of the feature map.

In some non-limiting embodiments or aspects, the method further comprises processing, with the computer system, the artificial neuron data associated with one or more artificial neurons of the one or more convolution layers to produce pooling neuron data associated with one or more pooling neurons of a pooling layer; and generating the prediction score for the one or more elements of the feature map comprises: generating, with the computer system, the prediction score for the one or more elements of the feature map based on the artificial neuron data and the pooling neuron data.

In some non-limiting embodiments or aspects, the method further comprises generating the prediction score for the one or more elements of the feature map comprising processing, with the computer system, the pooling neuron data with one or more deconvolution layers to produce the prediction score.

In some non-limiting embodiments or aspects, the method further comprises processing the artificial neuron data comprising combining, with the computer system, first artificial neuron data associated with a first artificial neuron in the one or more convolution layers and second artificial neuron data associated with a second artificial neuron in the one or more convolution layers to produce the pooling neuron data associated with the one or more pooling neurons of the pooling layer.

In some non-limiting embodiments or aspects, the one or more elements of the feature map comprise one or more first elements of the feature map. The method further comprises determining, with the computer system, a weighted average for the one or more first elements of the feature map, wherein the weighted average is determined based on a prediction score of one or more second elements of the feature map that are in proximity to the one or more first elements of the feature map; and the method further comprises: determining, with the computer system, the map data associated with the map based on the weighted average for the one or more first elements of the feature map.

In some non-limiting embodiments or aspects, processing the feature map data comprising scanning, with the computer system, the plurality of elements of the matrix of the feature map with a filter, the filter comprising a scanning window having a predetermined size; and producing, with the computer system, the artificial neuron data by combining weights of the plurality of elements of the matrix of the feature map with the filter, the artificial neuron data corresponding to the predetermined size of the scanning window.

In some non-limiting embodiments or aspects, the method further comprises determining, with the computer system, whether the one or more elements of the feature map comprise the parking location based on the prediction score of the one or more elements of the feature map; and the parking location comprises a segment of a parking lane of a roadway of the road.

According to some non-limiting embodiments or aspects, provided is a computing system for predicting one or more parking locations comprising: one or more processors to: receive a plurality of feature maps, wherein each feature map of the plurality of feature maps comprises a plurality of elements of a matrix, wherein each element of the matrix comprises feature map data, wherein the feature map data is associated with one or more features of a road; process the feature map data associated with the plurality of feature maps to produce artificial neuron data associated with a plurality of artificial neurons of a plurality of convolution layers; generate a prediction score for each element of the matrix of each feature map of the plurality of feature maps based on the artificial neuron data, wherein the prediction score comprises a prediction of whether each element of each feature map comprises a parking location; determining whether one or more elements of the matrix of the feature map comprises the parking location based on the prediction score of each element of the feature map; and output map data associated with a map based on determining that the one or more elements of the matrix of the feature map comprises the parking location.

In some non-limiting embodiments or aspects, the one or more processors are further programmed or configured to process the artificial neuron data associated with one or more artificial neurons of the plurality of convolution layers to produce pooling neuron data associated with one or more pooling neurons of a pooling layer; and the one or more processors, when generating the prediction score for the one or more elements of each feature map, is to: generate the prediction score for the one or more elements of each feature map based on the artificial neuron data and the pooling neuron data.

In some non-limiting embodiments or aspects, when generating the prediction score for the one or more elements of each feature map, the one or more processors are programmed or configured to process the pooling neuron data with one or more deconvolution layers to produce the prediction score.

In some non-limiting embodiments or aspects, when processing the artificial neuron data, the one or more processors are further programmed or configured to combine first artificial neuron data associated with a first artificial neuron in a first convolution layer of the plurality of convolution layers and second artificial neuron data associated with a second artificial neuron in the first convolution layer to produce the pooling neuron data.

In some non-limiting embodiments or aspects, the one or more processors are further programmed or configured to determine a weighted average for a plurality of first elements of a first feature map of the plurality of feature maps, wherein the weighted average is determined based on a prediction score of each element of a plurality of second elements of the first feature map that are in proximity to the plurality of first elements of the first feature map; and the one or more processors are further to: determine the map data associated with the map based on the weighted average of the plurality of first elements of the first feature map.

In some non-limiting embodiments or aspects, the one or more processors are further programmed or configured to scan the plurality of elements of the matrix of each feature map with a filter, the filter comprising a scanning window having a predetermined size; and produce the artificial neuron data by combining weights of the plurality of elements of the matrix of each feature map with the filter, the artificial neuron data corresponding to the predetermined size of the scanning window.

In some non-limiting embodiments or aspects, wherein the one or more processors, when outputting the map data associated with the map, are programmed or configured to: output the map data associated with the map that includes a labeled parking location associated with the parking location; and the labeled parking location comprises a segment of a parking lane of a roadway of the road.

According to some non-limiting embodiments or aspects, provided is an autonomous vehicle comprising: one or more sensors for detecting an object in an environment surrounding the autonomous vehicle; a vehicle computing system comprising one or more processors, wherein the vehicle computing system is to: receive autonomous vehicle (AV) map data associated with an AV map including one or more roads, the AV map including one or more prediction scores associated with one or more areas of the AV map, wherein the AV map data is determined based on: receiving feature map data associated with a feature map, wherein the feature map comprises a plurality of elements of a matrix, wherein each element of the matrix comprises the feature map data, wherein the feature map data is associated with one or more features of a road; processing the feature map data to produce artificial neuron data associated with one or more artificial neurons of one or more convolution layers; generating a prediction score for each element of the feature map based on the artificial neuron data, wherein the prediction score comprises a prediction of whether each element of the feature map comprises a parking location; and determining the AV map data based on generating the prediction score for each element of the feature map; and control travel of the autonomous vehicle based on sensor data from the one or more sensors and the AV map data associated with the AV map.

According to some non-limiting embodiments or aspects, a method for predicting one or more parking locations, comprises receiving, with a computing system comprising one or more processors, feature map data associated with a plurality of feature maps, each feature map including a matrix comprising one or more elements, each element of the one or more elements associated with feature map data, the feature map data associated with one or more features of a road, one or more elements in one feature map of the plurality of feature maps corresponding geospatially to one or more elements in another feature map of the plurality of feature maps; generating, with the computer system, one or more prediction scores associated with one or more geospatially corresponding elements in the feature maps based on the feature map data; and outputting, with the one or more processors, map data associated with a map, wherein the map data is based on the one or more prediction scores.

According to some non-limiting embodiments or aspects, provided is a computer program product including at least one non-transitory computer-readable medium including one or more instructions that, when executed by at least one processor, cause the at least one processor to: receive a plurality of feature maps, wherein each feature map of the plurality of feature maps comprises a plurality of elements of a matrix, wherein each element of the matrix comprises feature map data, wherein the feature map data is associated with one or more features of a road; process the feature map data associated with the plurality of feature maps to produce artificial neuron data associated with a plurality of artificial neurons of a plurality of convolution layers; generate a prediction score for each element of the matrix of each feature map of the plurality of feature maps based on the artificial neuron data, wherein the prediction score comprises a prediction of whether each element of each feature map comprises a parking location; determining whether one or more elements of the matrix of the feature map comprises the parking location based on the prediction score of each element of the feature map; and output map data associated with a map based on determining that the one or more elements of the matrix of the feature map comprises the parking location.

In some non-limiting embodiments or aspects, the computer program product includes further instructions that cause the at least one processor to process the artificial neuron data associated with one or more artificial neurons of the plurality of convolution layers to produce pooling neuron data associated with one or more pooling neurons of a pooling layer; and the one or more processors, when generating the prediction score for the one or more elements of each feature map, is to: generate the prediction score for the one or more elements of each feature map based on the artificial neuron data and the pooling neuron data.

In some non-limiting embodiments or aspects, when generating the prediction score for the one or more elements of each feature map, the computer program product includes further instructions that cause the at least one processor to process the pooling neuron data with one or more deconvolution layers to produce the prediction score.

In some non-limiting embodiments or aspects, when processing the artificial neuron data, the computer program product includes further instructions that cause the at least one processor to combine first artificial neuron data associated with a first artificial neuron in a first convolution layer of the plurality of convolution layers and second artificial neuron data associated with a second artificial neuron in the first convolution layer to produce the pooling neuron data.

In some non-limiting embodiments or aspects, the computer program product includes further instructions that cause the at least one processor to determine a weighted average for a plurality of first elements of a first feature map of the plurality of feature maps, wherein the weighted average is determined based on a prediction score of each element of a plurality of second elements of the first feature map that are in proximity to the plurality of first elements of the first feature map; and the one or more processors are further to: determine the map data associated with the map based on the weighted average of the plurality of first elements of the first feature map.

In some non-limiting embodiments or aspects, the computer program product includes further instructions that cause the at least one processor to scan the plurality of elements of the matrix of each feature map with a filter, the filter comprising a scanning window having a predetermined size; and produce the artificial neuron data by combining weights of the plurality of elements of the matrix of each feature map with the filter, the artificial neuron data corresponding to the predetermined size of the scanning window.

In some non-limiting embodiments or aspects, wherein the computer program product includes further instructions that, when outputting the map data associated with the map, cause the at least one processor to: output the map data associated with the map that includes a labeled parking location associated with the parking location; and the labeled parking location comprises a segment of a parking lane of a roadway of the road.

Further non-limiting embodiments or aspects are set forth in the following numbered clauses:

Clause 1: A method, comprising: receiving, with a computing system comprising one or more processors, feature map data associated with a feature map, wherein the feature map comprises a plurality of elements of a matrix, wherein one or more elements of the matrix comprises the feature map data, wherein the feature map data is associated with one or more features of a road; processing, with the computer system, the feature map data to produce artificial neuron data associated with one or more artificial neurons of one or more convolution layers; generating, with the computer system, a prediction score for the one or more elements of the feature map based on the artificial neuron data, wherein the prediction score comprises a prediction of whether an element of a feature map comprises a parking location; and outputting, with the computer system, map data associated with a map, wherein the map data is based on the one or more prediction scores associated with the one or more elements of the feature map.

Clause 2: The method of clause 1, further comprising: processing the artificial neuron data associated with one or more artificial neurons of the one or more convolution layers to produce pooling neuron data associated with one or more pooling neurons of a pooling layer; and wherein generating the prediction score for the one or more elements of the feature map comprises: generating the prediction score for the one or more elements of the feature map based on the artificial neuron data and the pooling neuron data.

Clause 3: The method of clauses 1 or 2, wherein generating the prediction score for the one or more elements of the feature map comprises: processing the pooling neuron data with one or more deconvolution layers to produce the prediction score.

Clause 4: The method of any of clauses 1-3, wherein processing the artificial neuron data comprises: combining first artificial neuron data associated with a first artificial neuron in the one or more convolution layers and second artificial neuron data associated with a second artificial neuron in the one or more convolution layers to produce the pooling neuron data associated with the one or more pooling neurons of the pooling layer.

Clause 5: The method of any of clauses 1-4, wherein the one or more elements of the feature map comprise one or more first elements of the feature map, the method further comprising: determining a weighted average for the one or more first elements of the feature map, wherein the weighted average is determined based on a prediction score of one or more second elements of the feature map that are in proximity to the one or more first elements of the feature map; and wherein the method further comprises: determining the map data associated with the map based on the weighted average for the one or more first elements of the feature map.

Clause 6: The method of any of clauses 1-5, wherein processing the feature map data comprises: scanning the plurality of elements of the matrix of the feature map with a filter, the filter comprising a scanning window having a predetermined size; and producing the artificial neuron data by combining weights of the plurality of elements of the matrix of the feature map with the filter, the artificial neuron data corresponding to the predetermined size of the scanning window.

Clause 7: The method of any of clauses 1-6, further comprising: determining whether the one or more elements of the feature map comprise the parking location based on the prediction score of the one or more elements of the feature map; and wherein the parking location comprises a segment of a parking lane of a roadway of the road.

Clause 8: A computing system, comprising: one or more processors to: receive a plurality of feature maps, wherein each feature map of the plurality of feature maps comprises a plurality of elements of a matrix, wherein each element of the matrix comprises feature map data, wherein the feature map data is associated with one or more features of a road; process the feature map data associated with the plurality of feature maps to produce artificial neuron data associated with a plurality of artificial neurons of a plurality of convolution layers; generate a prediction score for one or more elements of the matrix of each feature map of the plurality of feature maps based on the artificial neuron data, wherein the prediction score comprises a prediction of whether an element of a feature map comprises a parking location; determine whether one or more elements of the matrix of each feature map of the plurality of feature maps comprises the parking location based on the prediction score of the one or more elements of the matrix of each feature map; and output map data associated with a map based on determining that the one or more elements of the matrix of each feature map comprises the parking location.

Clause 9: The computing system of clause 8, wherein the one or more processors are further to: process the artificial neuron data associated with one or more artificial neurons of the plurality of convolution layers to produce pooling neuron data associated with one or more pooling neurons of a pooling layer; and wherein the one or more processors, when generating the prediction score for the one or more elements of each feature map, is to: generate the prediction score for the one or more elements of each feature map based on the artificial neuron data and the pooling neuron data.

Clause 10: The computing system of clauses 8 or 9, wherein the one or more processors, when generating the prediction score for the one or more elements of each feature map, are to: process the pooling neuron data with one or more deconvolution layers to produce the prediction score.

Clause 11: The computing system of any of clauses 8-10, wherein the one or more processors, when processing the artificial neuron data, are to: combine first artificial neuron data associated with a first artificial neuron in a first convolution layer of the plurality of convolution layers and second artificial neuron data associated with a second artificial neuron in the first convolution layer to produce the pooling neuron data.

Clause 12: The computing system of any of clauses 8-11, wherein the one or more processors are further to: determine a weighted average for a plurality of first elements of a first feature map of the plurality of feature maps, wherein the weighted average is determined based on a prediction score of each element of a plurality of second elements of the first feature map that are in proximity to the plurality of first elements of the first feature map; and wherein the one or more processors are further to: determine the map data associated with the map based on the weighted average of the plurality of first elements of the first feature map.

Clause 13: The computing system of any of clauses 8-12, wherein the one or more processors, when processing the feature map data, are to: scan the plurality of elements of the matrix of each feature map with a filter, the filter comprising a scanning window having a predetermined size; and produce the artificial neuron data by combining weights of the plurality of elements of the matrix of each feature map with the filter, the artificial neuron data corresponding to the predetermined size of the scanning window.

Clause 14: The computing system of any of clauses 8-13, wherein the one or more processors, when outputting the map data associated with the map, are to: output the map data associated with the map that includes a labeled parking location associated with the parking location; and wherein the labeled parking location comprises a segment of a parking lane of a roadway of the road.

Clause 15: An autonomous vehicle, comprising: one or more sensors for detecting an object in an environment surrounding the autonomous vehicle; and a vehicle computing system comprising one or more processors, wherein the vehicle computing system is to: receive autonomous vehicle (AV) map data associated with an AV map including one or more roads, the AV map including one or more prediction scores associated with one or more areas of the AV map, wherein the AV map data is determined based on: receiving feature map data associated with a feature map, wherein the feature map comprises a plurality of elements of a matrix, wherein each element of the matrix comprises the feature map data, wherein the feature map data is associated with one or more features of a road, processing the feature map data to produce artificial neuron data associated with one or more artificial neurons of one or more convolution layers, generating a prediction score for each element of the feature map based on the artificial neuron data, wherein the one or more prediction scores are associated with a prediction of whether each element of the feature map comprises a parking location, and determining the AV map data based on generating the one or more prediction scores for each element of the feature map; and control travel of the autonomous vehicle based on sensor data from the one or more sensors and the AV map data associated with the AV map.

Clause 16: The autonomous vehicle of clause 15, wherein the vehicle computing system is further to: determine that the one or more areas of the AV map comprise the parking location; and cause the autonomous vehicle to travel with respect to the parking location based on determining that the one or more areas of the AV map comprise the parking location.

Clause 17: The autonomous vehicle of clauses 15 or 16, wherein the vehicle computing system is further to: determine that the one or more areas of the AV map comprise the parking location; determine that another vehicle is located within the parking location based on the sensor data; and control the autonomous vehicle to travel with respect to the parking location based on determining that the another vehicle is located within the parking location.

Clause 18: The autonomous vehicle of any of clauses 15-17, wherein the parking location comprises a segment of a parking lane of a roadway of the road.

Clause 19: The autonomous vehicle of any of clauses 15-18, wherein the vehicle computing system is further to: determine that the one or more areas of the AV map comprise a feature of the one or more roads; and cause the autonomous vehicle to travel with respect to the parking location based on determining that the one or more areas of the AV map comprise the feature of the one or more roads.

Clause 20: The autonomous vehicle of any of clauses 15-19, wherein the vehicle computing system is further to: determine a pickup location for an individual based on the parking location; and cause the autonomous vehicle to travel with respect to the parking location based on determining the pickup location for the individual.

### BRIEF DESCRIPTION OF THE DRAWINGS

FIG. 1 is a schematic diagram of a non-limiting embodiment or aspect of an environment in which systems and/or methods, described herein, can be implemented;

FIG. 2 is a schematic diagram of a non-limiting embodiment or aspect of a system for controlling the autonomous vehicle shown in FIG. 1;

FIG. 3 is a schematic diagram of a non-limiting embodiment or aspect of components of one or more devices of FIGS. 1 and 2;

FIG. 4 is a flowchart of a non-limiting embodiment or aspect of a process for predicting parking locations based on image data;

FIG. 5 is a flowchart of a non-limiting embodiment or aspect of a process for predicting parking locations based on image data; and

FIGS. 6A-6C are diagrams of an implementation of a non-limiting embodiment or aspect of a process disclosed herein.

### DETAILED DESCRIPTION

The following detailed description of non-limiting embodiments refers to the accompanying drawings. The same reference numbers in different drawings identify the same or similar elements.

In some non-limiting embodiments, an autonomous vehicle is operated based on an autonomous vehicle (AV) map that includes data regarding features of a road upon which the autonomous vehicle travels. For example, the autonomous vehicle is operated based on a map (e.g., a vehicle map, an AV map) that includes a manual designation (e.g., a designation based on a determination from an individual) regarding a direction that the autonomous vehicle is to travel when the autonomous vehicle travels on the road. In some non-limiting embodiments, the autonomous vehicle may be required to park along a road. For example, the autonomous vehicle may be required to park in a parking location (e.g., a parking lane, a parking space, a parking space in a parking lane, parking spot, etc.) that is along the road on which the autonomous vehicle is traveling. In some non-limiting embodiments, the autonomous vehicle may use a map of the road to travel to the parking location on a map that includes a manual designation of the parking location.

However, an AV map that includes manual designations of parking locations may be inaccurate. In addition, an autonomous vehicle may not be able to travel to a parking location to park using the map. For example, an autonomous vehicle may not be able to determine (e.g., read) the parking location based on the inaccuracy in the AV map. Furthermore, generating an AV map that includes manual designations of parking locations in a geographic location may consume a large amount of network and/or processing resources and a large amount of time. Additionally, a map may not be able to be generated that includes all parking locations if an individual provides manual designations for the parking locations based on a lack of network and/or processing resources to generate the map, a lack of time to generate the map, and/or a lack of data to generate the map.

As disclosed herein, in some non-limiting embodiments, a parking prediction system receives image data (e.g., electronic image data, image data in an electronic format, image data in a file format, etc.) associated with an image of one or more roads and the image includes a matrix having one or more elements. In some non-limiting embodiments, the parking prediction system generates one or more prediction scores associated with the one or more elements of the matrix of the image, where the one or more prediction scores provide an indication of whether a location on the image of the geographic location includes a parking location. In some non-limiting embodiments, the one or more prediction scores provide an indication of whether the image of the one or more roads includes a parking location (e.g., a parking location that is available or is not available). In some non-limiting embodiments, the parking prediction system outputs map data associated with a map based on the one or more prediction scores.

In this way, the parking prediction system may generate a map that more accurately identifies whether an area in an image includes a parking location as compared to a map generated by an individual (e.g., a person, a human, etc.) that includes a manual designation of a parking location. In addition, the parking prediction system may allow an autonomous vehicle to be able to travel to a parking location to park using a map (e.g., a vehicle map, an AV map, etc.) generated based on the one or more prediction scores. Additionally, the parking prediction system may generate a map based on the one or more prediction scores using fewer network and/or processing resources and in less time than it takes to generate an AV map that includes a manual designation of a parking location in a geographic location. Furthermore, the parking prediction system may be able to generate a map based on the one or more prediction scores that includes all parking locations in a geographic location.

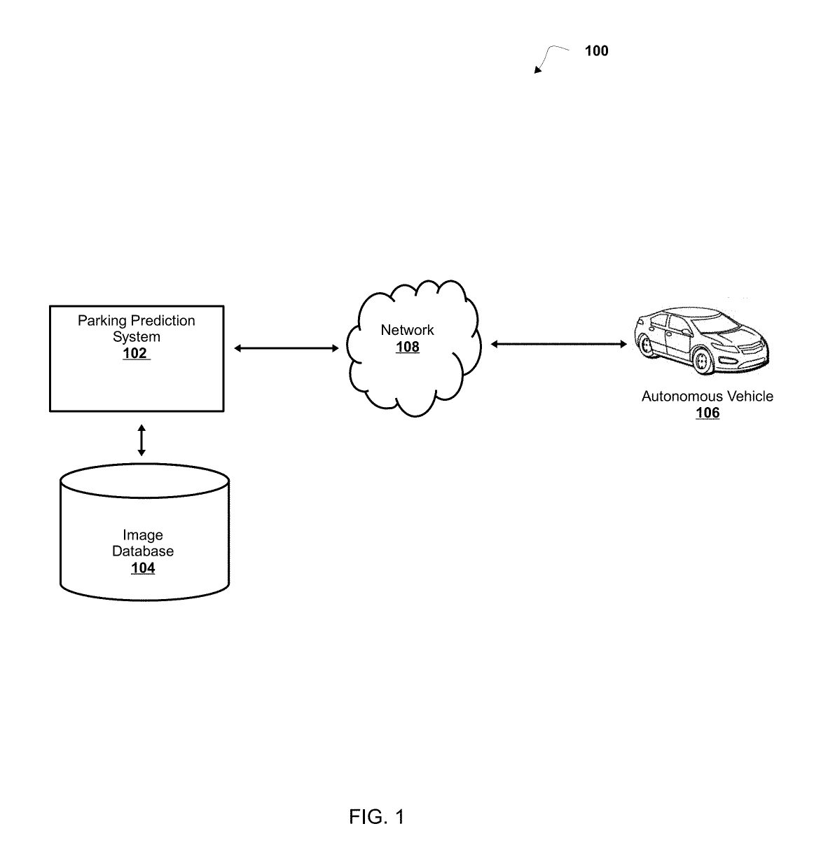

Referring now to FIG. 1, FIG. 1 is a diagram of a non-limiting embodiment of an environment 100 in which systems and/or methods, described herein, can be implemented. As shown in FIG. 1, environment 100 includes parking prediction system 102, image database 104, autonomous vehicle 106, and network 108. Systems and/or devices of environment 100 may interconnect via wired connections, wireless connections, or a combination of wired and wireless connections.

In some non-limiting embodiments, parking prediction system 102 includes one or more devices capable of receiving image data associated with an image (e.g., image data associated with an image of one or more roads, image data associated with an image of a geographic location, image data associated with an image of a vehicle map, image data associated with a feature map that includes features of one or more roads, etc.), storing the image data, processing the image data, and/or providing the image data. For example, parking prediction system 102 include one or more computing systems comprising one or more processors (e.g., one or more servers, etc.). In some non-limiting embodiments, parking prediction system 102 is capable of processing the image data to generate a prediction (e.g., a prediction score, a parking location prediction score, etc.) of whether an image includes a parking location. In some non-limiting embodiments, parking prediction system 102 is capable of providing map data associated with a map (e.g., vehicle map data associated with a vehicle map, AV map data associated with an AV map) to autonomous vehicle 106.

In some non-limiting embodiments, image database 104 includes one or more devices capable of receiving, storing, and/or providing image data associated with an image. For example, image database 104 include one or more computing systems comprising one or more processors (e.g., one or more servers, etc.). In some non-limiting embodiments, image database 104 includes one or more data structures for storing the image data. In some non-limiting embodiments, parking prediction system include image database 104.

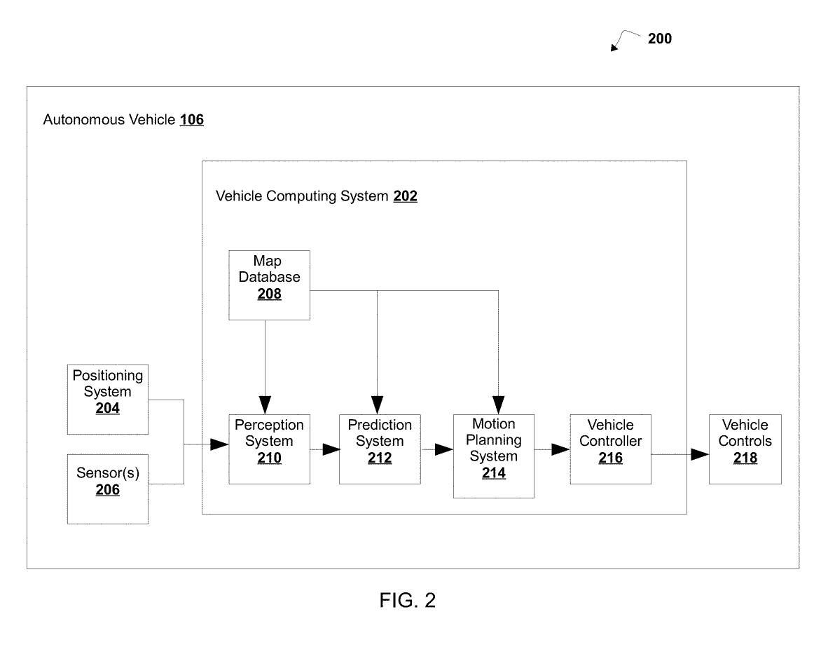

In some non-limiting embodiments, autonomous vehicle 106 includes one or more devices capable of receiving, storing, processing, and/or providing map data associated with a map (e.g., vehicle map data associated with a vehicle map, AV map data associated with an AV map, etc.). For example, autonomous vehicle 106 includes one or more computing systems comprising one or more processors (e.g., one or more servers, etc.). In some non-limiting embodiments, autonomous vehicle 106 receives AV map data associated with an AV map and autonomous vehicle 106 travels to a location on the AV map based on the map data. Further details regarding non-limiting embodiments of autonomous vehicle 106 are provided below with regard to FIG. 2.

In some non-limiting embodiments, network 108 includes one or more wired and/or wireless networks. For example, network 108 include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices, and networks shown in FIG. 1 are provided as an example. There can be additional systems, devices and/or networks, fewer systems, devices, and/or networks, different systems, devices and/or networks, or differently arranged systems, devices, and/or networks than those shown in FIG. 1. Furthermore, two or more systems or devices shown in FIG. 1 can be implemented within a single system or a single device, or a single system or a single device shown in FIG. 1 can be implemented as multiple, distributed systems or devices. Additionally, or alternatively, a set of systems or a set of devices (e.g., one or more systems, one or more devices) of environment 100 can perform one or more functions described as being performed by another set of systems or another set of devices of environment 100.

Referring now to FIG. 2, FIG. 2 is a diagram of a non-limiting embodiment of a system 200 for controlling autonomous vehicle 106. As shown in FIG. 2, vehicle computing system 202 includes perception system 210, prediction system 212, and motion planning system 214 that cooperate to perceive a surrounding environment of autonomous vehicle 106 and determine a motion plan (e.g., plan for traveling on one or more routes, etc.) for controlling the motion (e.g., a direction of travel) of autonomous vehicle 106 accordingly.

In some non-limiting embodiments, vehicle computing system 202 is connected to or includes positioning system 204. In some non-limiting embodiments, positioning system 204 determines a location (e.g., a current location, a past location, etc.) of autonomous vehicle 106. In some non-limiting embodiments, positioning system 204 determines a location of autonomous vehicle 106 based on an inertial sensor, a satellite positioning system, an IP address (e.g., an IP address of autonomous vehicle 106, an IP address of a device in autonomous vehicle 106, etc.), triangulation based on network components (e.g., network access points, cellular towers, WiFi access points, etc.), and/or proximity to network components, and/or the like. In some non-limiting embodiments, the location of autonomous vehicle 102 is used by vehicle computing system 106.

In some non-limiting embodiments, perception system 210 receives sensor data from one or more sensors 206 that are coupled to or otherwise included in autonomous vehicle 106. For example, one or more sensors 206 include a Light Detection and Ranging (LIDAR) system, a Radio Detection and Ranging (RADAR) system, one or more cameras (e.g., visible spectrum cameras, infrared cameras, etc.), and/or the like. In some non-limiting embodiments, the sensor data includes data that describes a location of objects within the surrounding environment of the autonomous vehicle 106. In some non-limiting embodiments, one or more sensors 206 collect sensor data that includes data that describes a location (e.g., in three-dimensional space relative to the autonomous vehicle 106) of points that corresponds to objects within the surrounding environment of autonomous vehicle 106.

In some non-limiting embodiments, the sensor data includes a location (e.g., a location in three-dimensional space relative to the LIDAR system) of a number of points (e.g., a point cloud) that correspond to objects that have reflected a ranging laser. In some non-limiting embodiments, the LIDAR system measures distances by measuring a Time of Flight (TOF) that a short laser pulse takes to travel from a sensor of the LIDAR system to an object and back, and the LIDAR system calculates the distance of the object to the LIDAR system based on the known speed of light.

In some non-limiting embodiments, the sensor data includes a location (e.g., a location in three-dimensional space relative to the RADAR system) of a number of points that correspond to objects that have reflected a ranging radio wave. In some non-limiting embodiments, radio waves (e.g., pulsed radio waves or continuous radio waves) transmitted by the RADAR system can reflect off an object and return to a receiver of the RADAR system. The RADAR system can then determine information about the object's location and/or speed. In some non-limiting embodiments, the RADAR system provides information about the location and/or the speed of an object relative to the RADAR system based on the radio waves.

In some non-limiting embodiments, image processing techniques (e.g., range imaging techniques such as, for example, structure from motion, structured light, stereo triangulation, etc.) can be performed by system 200 to identify a location (e.g., in three-dimensional space relative to the one or more cameras) of a number of points that corresponds to objects that are depicted in images captured by one or more cameras. Other sensors identify the location of points that corresponds to objects as well.

In some non-limiting embodiments, perception system 210 detects and/or tracks objects (e.g., vehicles, pedestrians, bicycles, and the like) that are proximate to (e.g., in proximity to the surrounding environment of) the autonomous vehicle 106 over a time period. In some non-limiting embodiments, perception system 210 retrieves (e.g., obtain) a map and/or map data associated with the map from map database 208 (e.g., autonomous vehicle (AV) map data) that provides detailed information about the surrounding environment of the autonomous vehicle 106.

In some non-limiting embodiments, perception system 210 determines one or more objects that are proximate to autonomous vehicle 106 based on sensor data received from one or more sensors 206 and/or map data (e.g. AV map data) from map database 208. For example, perception system 210 determines, for the one or more objects that are proximate, state data associated with a state of such object. In some non-limiting embodiments, the state data associated with an object includes data associated with a location of the object (e.g., a location, a current location, an estimated location, etc.), data associated with a speed of the object (e.g., a magnitude of velocity of the object), data associated with a direction of travel of the object (e.g., a heading, a current heading, etc.), data associated with acceleration rate of the object (e.g., an estimated acceleration rate of the object, etc.), data associated with an orientation of the object (e.g., a current orientation, etc.), data associated with a size of the object (e.g., a size of the object as represented by a bounding shape such as a bounding polygon or polyhedron, a footprint of the object, etc.), data associated with a type of the object (e.g., a class of the object, an object with a type of vehicle, an object with a type of pedestrian, an object with a type of bicycle, etc.), and/or the like.

In some implementations, perception system 210 determines state data for an object over a number of iterations of determining state data. For example, perception system 210 updates the state data for each object of a plurality of objects during each iteration.

In some non-limiting embodiments, prediction system 212 receives the state data associated with one or more objects from perception system 210. Prediction system 212 predict one or more future locations for the one or more objects based on the state data. For example, prediction system 212 predicts the future location of each object of a plurality of objects within a time period (e.g., 5 seconds, 10 seconds, 20 seconds, etc.). In some non-limiting embodiments, prediction system 212 predicts that an object will follow (e.g., adhere to) the object's direction of travel according to the speed of the object. In some non-limiting embodiments, prediction system 212 uses machine learning techniques or modeling techniques to make a prediction based on state data associated with an object.

In some non-limiting embodiments, motion planning system 214 determines a motion plan for autonomous vehicle 106 based on a prediction of a location associated with an object provided by prediction system 212 and/or based on state data associated with the object provided by perception system 210. For example, motion planning system 214 determine a motion plan (e.g., an optimized motion plan) for the autonomous vehicle 106 that causes autonomous vehicle 106 to travel relative to the object based on the prediction of the location for the object provided by prediction system 212 and/or the state data associated with the object provided by perception system 210.

In some non-limiting embodiments, motion planning system 214 determines a cost function for each of one or more motion plans for autonomous vehicle 106 based on the locations and/or predicted locations of one or more objects. For example, motion planning system 214 determines the cost function that describes a cost (e.g., a cost over a time period) of following (e.g., adhering to) a motion plan (e.g., a selected motion plan, an optimized motion plan, etc.). In some non-limiting embodiments, the cost associated with the cost function increases and/or decreases based on autonomous vehicle 106 deviating from a motion plan (e.g., a selected motion plan, an optimized motion plan, a preferred motion plan, etc.). For example, the cost associated with the cost function increases and/or decreases based on autonomous vehicle 106 deviating from the motion plan to avoid a collision with an object.

In some non-limiting embodiments, motion planning system 214 determines a cost of following a motion plan. For example, motion planning system 214 determines a motion plan for autonomous vehicle 106 based on one or more cost functions. In some non-limiting embodiments, motion planning system 214 determines a motion plan (e.g., a selected motion plan, an optimized motion plan, a preferred motion plan, etc.) that minimizes a cost function. In some non-limiting embodiments, motion planning system 214 provides a motion plan to vehicle controller 216 and vehicle controller 216 controls one or more vehicle controls 218 (e.g., a device that controls acceleration, a device that controls steering, a device that controls braking, an actuator that control gas flow, etc.) to implement the motion plan.

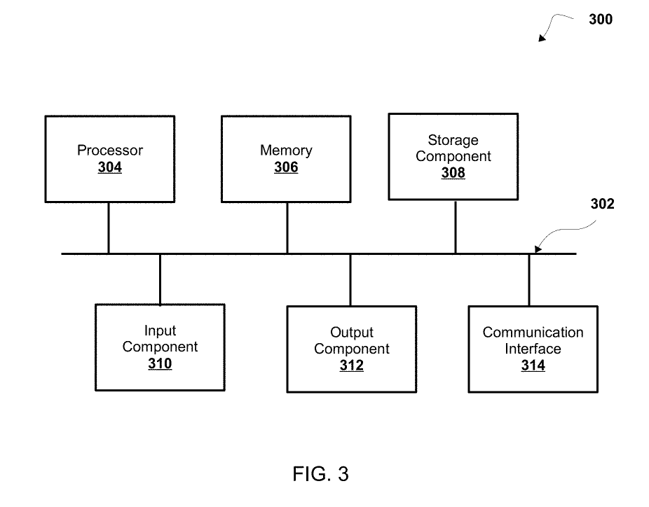

Referring now to FIG. 3, FIG. 3 is a diagram of example components of a device 300. Device 300 corresponds to one or more devices of parking prediction system 102, one or more devices of image database 104, and/or one or more devices (e.g., one or more devices of a system of) autonomous vehicle 106. In some non-limiting embodiments, one or more devices of parking prediction system 102, one or more devices of image database 104, and/or one or more devices (e.g., one or more devices of a system of) autonomous vehicle 106 include at least one device 300 and/or at least one component of device 300. As shown in FIG. 3, device 300 includes bus 302, processor 304, memory 306, storage component 308, input component 310, output component 312, and communication interface 214.

Bus 302 includes a component that permits communication among the components of device 300. In some non-limiting embodiments, processor 304 is implemented in hardware, firmware, or a combination of hardware and software. For example, processor 304 includes a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 includes a random access memory (RAM), a read-only memory (ROM), and/or another type of dynamic or static storage device (e.g., flash memory, magnetic memory, optical memory, etc.) that stores information and/or instructions for use by processor 304.

Storage component 308 stores information and/or software related to the operation and use of device 300. For example, storage component 308 includes a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 310 includes a component that permits device 300 to receive information, such as via user input (e.g., a touch screen display, a keyboard, a keypad, a mouse, a button, a switch, a microphone, etc.). Additionally, or alternatively, input component 310 includes a sensor for sensing information (e.g., a global positioning system (GPS) component, an accelerometer, a gyroscope, an actuator, etc.). Output component 312 includes a component that provides output information from device 300 (e.g., a display, a speaker, one or more light-emitting diodes (LEDs), etc.).

Communication interface 314 includes a transceiver-like component (e.g., a transceiver, a separate receiver and transmitter, etc.) that enables device 300 to communicate with other devices, such as via a wired connection, a wireless connection, or a combination of wired and wireless connections. Communication interface 314 permit device 300 to receive information from another device and/or provide information to another device. For example, communication interface 314 includes an Ethernet interface, an optical interface, a coaxial interface, an infrared interface, a radio frequency (RF) interface, a universal serial bus (USB) interface, a Wi-Fi interface, a cellular network interface, and/or the like.

In some non-limiting embodiments, device 300 performs one or more processes described herein. In some non-limiting embodiments, device 300 performs these processes based on processor 304 executing software instructions stored by a computer-readable medium, such as memory 306 and/or storage component 308. A computer-readable medium (e.g., a non-transitory computer-readable medium) is defined herein as a non-transitory memory device. A memory device includes memory space located inside of a single physical storage device or memory space spread across multiple physical storage devices.

Software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry is used in place of or in combination with software instructions to perform one or more processes described herein. Thus, embodiments described herein are not limited to any specific combination of hardware circuitry and software.

The number and arrangement of components shown in FIG. 3 are provided as an example. In some non-limiting embodiments, device 300 includes additional components, fewer components, different components, or differently arranged components than those shown in FIG. 3. Additionally, or alternatively, a set of components (e.g., one or more components) of device 300 performs one or more functions described as being performed by another set of components of device 300.

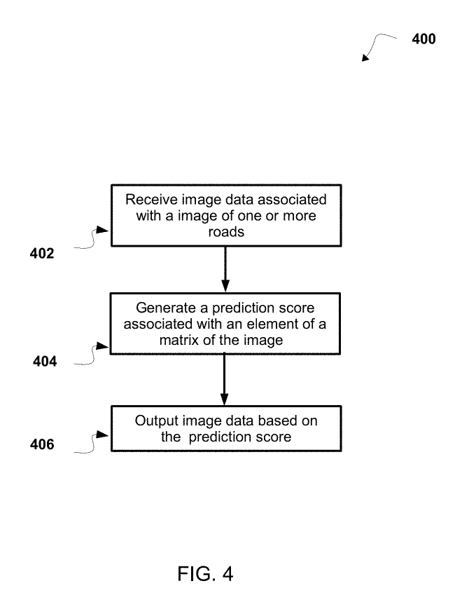

Referring now to FIG. 4, FIG. 4 is a flowchart of a non-limiting embodiment of a process 400 for predicting a parking location based on image data. In some non-limiting embodiments, one or more of the steps of process 400 can be performed (e.g., completely, partially, etc.) by parking prediction system 102 (e.g., one or more devices of parking prediction system 102). In some non-limiting embodiments, one or more of the steps of process 400 can be performed (e.g., completely, partially, etc.) by another device or a group of devices separate from or including parking prediction system 102, such as image database 104 (e.g., one or more devices of image database 104), or autonomous vehicle 106 (e.g., one or more devices of autonomous vehicle 106).

As shown in FIG. 4, at step 402, process 400 includes receiving image data associated with an image of one or more roads. For example, parking prediction system 102 receives image data associated with an image of one or more roads (e.g., an image of one or more roads that include a parking location; an image of a geographic location that includes one or more roads, such as a geographic location image; an image of one or more roads that includes data associated with operating a vehicle on the one or more road, such as a vehicle map; an image of one or more roads that includes features of the one or more roads, such as a feature map; an image of one or more parking locations located in a map, such as a map; etc.). In some non-limiting embodiments, parking prediction system 102 receives the image data and/or the image from image database 104. For example, parking prediction system 102 receives the image data and/or the image from image database 104 based on parking prediction system 102 receiving a request for vehicle map data associated with a vehicle map (e.g., a request for updated AV map data associated with an updated AV map) from autonomous vehicle 106.

In some non-limiting embodiments, the image data is associated with an image of one or more roads and the one or more roads include one or more parking locations in proximity to (e.g., within a predetermined distance of, adjacent, near, etc.) the one or more roads and/or within the one or more roads. For example, the image data includes image data associated with an image of a geographic location (e.g., geographic location image data), image data associated with a vehicle map (e.g., vehicle map data), and/or image data associated with a feature map of features of one or more roads (e.g., feature map data).

In some non-limiting embodiments, the image includes a matrix (e.g., a grid, a rectangular array, a multi-dimensional grid, a multi-dimensional array, a set of rows and columns, etc.) that has a plurality of elements (e.g., units, cells, pixels, etc.). Each element of the matrix includes image data (e.g., a value of image data, a value of geographic location image data, a value of vehicle map data, a value of feature map data, a value of a prediction score of map, etc.) associated with the image. In some non-limiting embodiments, the size of an element of the matrix corresponds to the size of the subject matter of the image based on a scale (e.g., the ratio of the size of an element to the corresponding size in the real world) of the image. For example, the size of one element corresponds to a shape with a predetermined dimension (e.g., a 0.1 m by 0.1 m square, a 1 m by 1 m square, a triangle with sides having a length of 0.1 m, etc.) in the real world.

In some non-limiting embodiments, each element of an image is associated with three dimensions. For example, a first dimension of the element is a width of the element, a second dimension of the element is a length of the element, and a third dimensions is a value associated with the image data of the element. In some non-limiting embodiments, at least one element in one image of a plurality of images corresponds geospatially to at least one element in at least one other image of the plurality of images. For example, a location (e.g., a coordinate) of a first element of a first image in a first matrix is the same as a location (e.g., a coordinate) of a second element of a second image in a second matrix. In another example, a location (e.g., a coordinate) of a first element of a first image in a first matrix is offset from a location (e.g., a coordinate) of a second element of a second image in a second matrix. In some non-limiting embodiments, a size and/or a location of one or more elements of a matrix of an image and a size and/or a location of one or more elements of a matrix of another image correspond to a same size and/or a same location of the subject matter of the image in the real world. For example, a first location of one or more elements in a matrix of a first image represent a subject matter in the real world and a second location of one or more elements in a matrix of a second image represent the same subject matter in the real world. In some non-limiting embodiments, a size and/or a location of one or more elements of a matrix of an image and a size and/or a location of one or more elements of a matrix of another image correspond to a different size and/or a different location of the subject matter of the image in the real world. For example, a first location of one or more elements in a matrix of a first image represent a subject matter in the real world and a second location of one or more elements in a matrix of a second image represent different subject matter in the real world.

In some non-limiting embodiments, parking prediction system 102 receives feature map data associated with one or more feature maps. In some non-limiting embodiments, feature map data includes data associated with one or more features of a road. In some non-limiting embodiments, a road refers to a paved or otherwise improved path between two places that allows for travel by a vehicle (e.g., an autonomous vehicle). Additionally or alternatively, a road includes a roadway and a sidewalk in proximity to (e.g., adjacent, near, next to, touching, etc.) the roadway. In some non-limiting embodiments, a roadway includes a portion of road on which a vehicle is intended to travel and is not restricted by a physical barrier or by separation so that the vehicle is able to travel laterally. Additionally or alternatively, a roadway includes one or more lanes, such as a travel lane (e.g., a lane upon which a vehicle travels, a traffic lane, etc.), a parking lane (e.g., a lane in which a vehicle parks), a bicycle lane (e.g., a lane in which a bicycle travels), a turning lane (e.g., a lane from which a vehicle turns), and/or the like. In some non-limiting embodiments, the feature map data is based on data collected by and/or received from one or more sensors located on an autonomous vehicle as the autonomous vehicle travels on one or roads in a geographic location.

In some non-limiting embodiments, the feature map data includes data associated with one or more features of a road. For example, the feature map data includes data associated with a road edge of a road (e.g., a location of a road edge of a road, a distance of location from a road edge of a road, an indication whether a location is within a road edge of a road, etc.), data associated with an intersection of a road with another road, data associated with a roadway of a road, data associated with a lane of a roadway of a road (e.g., a travel lane of a roadway, a parking lane of a roadway, a turning lane of a roadway, lane markings, a direction of travel in a lane of a roadway, etc.), data associated with one or more objects (e.g., a vehicle, vegetation, an individual, a structure, a building, a sign, a lamppost, signage, etc.) in proximity to and/or within a road (e.g., objects in proximity to the road edges of a road and/or within the road edges of a road), data associated with a sidewalk of a road, and/or the like.

In some non-limiting embodiments, parking prediction system 102 determines the feature map data associated with a feature map. For example, parking prediction system 102 receives data from one or more sensors located on an autonomous vehicle. Parking prediction system 102 determines the feature map data based on the data received from and/or collected by one or more sensors located on an autonomous vehicle as the autonomous vehicle travels on a road (e.g., a road located in the feature map). Additionally or alternatively, parking prediction system 102 determines the feature map data based on a manual input from an individual. For example, parking prediction system 102 determines the feature map data based on one or more features of a road that are labeled by an individual.

In some non-limiting embodiments, parking prediction system 102 generates one or more feature maps. For example, parking prediction system 102 generates one or more feature maps based on one or more vehicle maps (e.g., one or more vehicle maps corresponding to the one or more feature maps) and/or one or more geographic location images (e.g., one or more geographic location images corresponding to the one or more feature maps). In some non-limiting embodiments, parking prediction system 102 generates one or more feature maps that correspond to (e.g., correspond in size to, correspond based on an area encompassed by, correspond based on a location encompassed by, etc.) the one or more vehicle maps and/or one or more geographic location images. For example, parking prediction system 102 generates one or more feature maps that include one or more roads that correspond to one or more roads included in the one or more vehicle maps and/or to one or more roads included in the one or more geographic location images.

In some non-limiting embodiments, parking prediction system 102 generates the one or more feature maps based on extracting the feature map data from a vehicle map and/or a geographic location image. For example, parking prediction system 102 extracts the feature map data from a vehicle map and/or a geographic location image based on receiving vehicle map and/or a geographic location image and parking prediction system 102 generates the one or more feature maps after extracting the feature map data from a vehicle map and/or a geographic location image.

In some non-limiting embodiments, a feature map includes a histogram (e.g., a two dimensional histogram, a two dimensional histogram of cloud points representing a feature of a road, a normalized histogram, etc.) associated with a feature of a road included in feature map. In some non-limiting embodiments, a histogram includes a color associated with a value of a feature in each element (e.g., a cell, a pixel) of the feature map. For example, a histogram includes a darker shade of a color to indicate that a feature is likely to be present in an element of the feature map, and the histogram includes a lighter shade of a color to indicate that a feature is not likely to be present in an element of the feature map. In another example, a histogram includes a shade of a first color to indicate that a feature is likely to be present in an element of the feature map, and the histogram includes a shade of a second color to indicate that a feature is not likely to be present in an element of the feature map. In some non-limiting embodiments, the color varies among shades of red, green, and blue (RGB).

In some non-limiting embodiments, a feature map includes a histogram associated with one or more features of a road. For example, the feature map includes a histogram associated with a road edge of a road (e.g., a location of a road edge of a road, a distance of location from a road edge of a road, an indication whether a location is within a road edge of a road, etc.), a histogram associated with an intersection of a road with another road, a histogram associated with a roadway of a road, a histogram associated with a lane of a roadway of a road (e.g., a travel lane of a roadway, a parking lane of a roadway, a turning lane of a roadway, lane markings, a direction of travel in a lane of a roadway, etc.), a histogram associated with one or more objects (e.g., a vehicle, vegetation, an individual, a structure, a building, a sign, a lamppost, signage, etc.) in proximity to and/or within a road (e.g., objects in proximity to the road edges of a road and/or within the road edges of a road), a histogram associated with a sidewalk of a road, and/or the like.

Additionally or alternatively, a feature map includes a histogram of an intensity of a color (e.g., black, white, etc.) of a plurality of colors associated with a plurality of features of a road. In some non-limiting embodiments, parking prediction system 102 determines an area (e.g., a homogeneous area) of a feature map based on the histogram of the intensity of the color. For example, parking prediction system 102 determines a lane of a roadway (e.g., a parking lane, a travel lane, etc.) in the feature map based on the intensity of the color being the same in a portion of the feature map that includes the lane. Additionally or alternatively, a feature map includes a top down camera image (e.g., a synthesized RGB image taken by a camera) of the geographic location. In some non-limiting embodiments, parking prediction system 102 determines an area (e.g., a homogeneous area) of a geographic location based on the top down camera image. For example, parking prediction system 102 determines a lane of a roadway in the geographic location based on the color being the same in the top down camera image of the geographic location that includes the lane.

In some non-limiting embodiments, parking prediction system 102 receives geographic location image data associated with an image of a geographic location (e.g., a geographic location image). In some non-limiting embodiments, a geographic location image includes an image of a geographic location that includes one or more roads. In some non-limiting embodiments, the geographic location image data (e.g., data associated with a photograph, data associated with a picture, data associated with an aerial photograph, etc.) and/or the image of the geographic location is received from an online source (e.g., maps from Uber, Bing maps, Google Maps, Mapquest, etc.). In some non-limiting embodiments, the geographic location includes a country, a state, a city, a portion of a city, a township, a portion of a township, and/or the like. In some non-limiting embodiments, the image of the geographic location includes one or more roads (e.g., one road, a portion of the roads, all of the roads, etc.) in the geographic location.

In some non-limiting embodiments, parking prediction system 102 generates a vehicle map (e.g., a map of one or more roads, a vehicle map of a geographic location, a non-autonomous vehicle map, an AV map, an AV submap, etc.). For example, parking prediction system 102 generates the vehicle map based on geographic location image data associated with a geographic location image and/or feature map data associated with a feature map. In some non-limiting embodiments, a vehicle map include an image of one or more roads and is associated with operating a vehicle on the one or more road. In some non-limiting embodiments, the vehicle map data includes data associated with operating a vehicle on the one or more roads of the vehicle map. In some non-limiting embodiments, the vehicle map includes a map (e.g., a vehicle map, a non-autonomous vehicle map, an AV map, etc.) that is generated based on data received from one or more sensors located on autonomous vehicle 106.

As further shown in FIG. 4, at step 404, process 400 includes generating a prediction score associated with an element of a matrix of the image of the one or more roads. For example, parking prediction system 102 generates one or more prediction scores (e.g., a parking location prediction score) associated with an element of the matrix of the image of the one or more roads based on receiving the image data associated with the image. In some non-limiting embodiments, a prediction score includes an indication (e.g., a score, a number, a ranking, etc.) whether an element of the matrix of the image includes a parking location. In some non-limiting embodiments, parking prediction system 102 generates one or more prediction scores (e.g., one or more parking location prediction scores) associated with one or more elements (e.g., each element of a plurality of elements, a portion of elements of the plurality of elements, etc.) of the matrix of the image.

In some non-limiting embodiments, parking prediction system 102 generates the one or more prediction scores based on a machine learning technique (e.g., a pattern recognition technique, a data mining technique, a heuristic technique, a supervised learning technique, an unsupervised learning technique, etc.). For example, parking prediction system 102 generates a model (e.g., an estimator, a classifier, a prediction model, a parking location prediction model, etc.) based on a machine learning algorithm (e.g., a decision tree algorithm, a gradient boosted decision tree algorithm, a neural network algorithm, a convolutional neural network algorithm, etc.). In such an example, parking prediction system 102 generates the one or more prediction scores using the model.

In some non-limiting embodiments, parking prediction system 102 generates the model (e.g., a parking location prediction model) based on image data associated with an image of one or more roads that include a parking location. In some implementations, the model is designed to receive, as an input, image data associated with one or more images of one or more roads that include one or more parking locations, and provide, as an output, a prediction (e.g., a probability, a binary output, a yes-no output, a score, a prediction score, a parking location prediction score, etc.) as to whether the image (e.g., the entire image, an area of the image, an element of the image, etc.) includes one or more parking locations. In one example, the model is designed to receive image data associated with an image of one or more roads, and provide an output that predicts whether the image includes one or more parking locations (e.g., one or more parking locations in proximity to and/or within the one or more roads) in which a vehicle (e.g., autonomous vehicle 106) may park. In some non-limiting embodiments, parking prediction system 102 stores the model (e.g., stores the model for later use). In some non-limiting embodiments, parking prediction system 102 stores the model in a data structure (e.g., a database, a linked list, a tree, etc.). In some non-limiting embodiments, the data structure is located within parking prediction system 102 or external (e.g., remote from) parking prediction system 102.

In some non-limiting embodiments, parking prediction system 102 processes the image data to obtain training data for the model. For example, parking prediction system 102 processes the image data to change the image data into a format that is analyzed (e.g., by parking prediction system 102) to generate the model. The image data that is changed is referred to as training data. In some implementations, parking prediction system 102 processes the image data to obtain the training data based on receiving the image data. Additionally, or alternatively, parking prediction system 102 processes the image data to obtain the training data based on parking prediction system 102 receiving an indication that parking prediction system 102 is to process the image data from a user of parking prediction system 102, such as when parking prediction system 102 receives an indication to creates a model for a portion of a geographic location image, a portion of a vehicle map, and/or a portion of a feature map.

In some non-limiting embodiments, parking prediction system 102 processes the image data by determining an image variable based on the image data. In some non-limiting embodiments, an image variable includes a metric, associated with a parking location, which are derived based on the image data. The image variable is analyzed to generate a model. For example, the image variable includes a variable associated with geographic location image data associated with a geographic location image, vehicle map data associated with a vehicle map, feature map data associated with a feature map. In some non-limiting embodiments, the image variable is a variable associated with a feature of a road. For example, the image variable is a variable associated with a road edge of a road (e.g., a variable associated with a location of a road edge of a road, a variable associated with a distance of location from a road edge of a road, a variable associated with an indication whether a location is within a road edge of a road, etc.), a variable associated with an intersection of a road with another road, a variable associated with a roadway of a road, a variable associated with a lane of a roadway of a road (e.g., a variable associated with a travel lane of a roadway, a variable associated with a parking lane of a roadway, a variable associated with a turning lane of a roadway, a variable associated with lane markings of a lane, a variable associated with a direction of travel in a lane of a roadway, etc.), a variable associated with one or more objects in proximity to and/or within a road, a variable associated with a sidewalk of a road, and/or the like. Additionally or alternatively, the image variable includes a variable associated with an intensity of a color (e.g., black, white, etc.).

In some non-limiting embodiments, parking prediction system 102 analyzes the training data to generate a model (e.g., a prediction model). For example, parking prediction system 102 uses machine learning techniques to analyze the training data to generate the model. In some implementations, generating the model (e.g., based on training data obtained from image data, based on training data obtained from historical image data) is referred to as training the model. The machine learning techniques include, for example, supervised and/or unsupervised techniques, such as decision trees (e.g., gradient boosted decision trees), logistic regressions, artificial neural networks (e.g., convolutional neural networks), Bayesian statistics, learning automata, Hidden Markov Modeling, linear classifiers, quadratic classifiers, association rule learning, and/or the like. In some non-limiting embodiments, the model includes a prediction model that is specific to a particular geographic location, a particular vehicle map, a particular feature map, particular image data associated with an image of a geographic location, particular image data associated with an image of a vehicle map, particular image data associated with an image of a feature map, and/or the like. Additionally, or alternatively, the prediction model is specific to a particular user (e.g., an operator of an autonomous vehicle, an entity that operates an autonomous vehicle, etc.). In some implementations, parking prediction system 102 generates one or more prediction models (e.g., one or more parking prediction models) for one or more operators of one or more autonomous vehicles (e.g., one or more autonomous vehicles 106), a particular group of autonomous vehicles, and/or the like.

Additionally, or alternatively, when analyzing the training data, parking prediction system 102 identifies one or more image variables (e.g., one or more independent image variables) as predictor variables that are used to make a prediction (e.g., when analyzing the training data). In some implementations, values of the predictor variables are inputs to the model. For example, parking prediction system 102 identifies a subset (e.g., a proper subset) of image variables as predictor variables that are used to accurately predict whether an image of one or more roads includes a parking location. In some implementations, the predictor variables include one or more of the image variables, as discussed above, that have a significant impact (e.g., an impact satisfying a threshold) on a probability that the image of the one or more roads includes a parking location.

In some non-limiting embodiments, parking prediction system 102 validates the model. For example, parking prediction system 102 validates the model after parking prediction system 102 generates the model. In some implementations, parking prediction system 102 validates the model based on a portion of the training data to be used for validation. For example, parking prediction system 102 partitions the training data into a first portion and a second portion, where the first portion is used to generate the model, as described above. In this example, the second portion of the training data (e.g., the validation data) is used to validate the model. In some non-limiting embodiments, the first portion of the training data is different from the second portion of the training data.

In some implementations, parking prediction system 102 validates the model by providing validation data associated with an image of one or more roads as input to the model, and determining, based on an output of the prediction model, whether the prediction model correctly, or incorrectly, predicted that the image of the one or more roads includes a parking location. In some implementations, parking prediction system 102 validates the model based on a validation threshold (e.g., a threshold value of the validation data). For example, parking prediction system 102 is configured to validate the model when an image of one or more roads is correctly predicted by the model (e.g., when the prediction model correctly predicts 50% of the validation data, when the prediction model correctly predicts 70% of the validation data, etc.) as including a parking location.

In some implementations, if parking prediction system 102 does not validate the model (e.g., when a percentage of validation data does not satisfy the validation threshold), then parking prediction system 102 generates additional prediction models.

In some non-limiting embodiments, once the model has been validated, parking prediction system 102 further trains the model and/or creates new models based on receiving new training data. In some non-limiting embodiments, the new training data includes image data associated with an image of one or more roads that is different from a previous image of one or more roads.

In some non-limiting embodiments, parking prediction system 102 generates a prediction score for an element of a matrix of one or more images (e.g., one or more geographic location images, one or more vehicle maps, one or more feature maps, etc.) using a decision tree model (e.g., a boosted decision tree, a gradient boosted decision tree, etc.). In one example, parking prediction system 102 receives one or more feature maps that include feature map data associated with one or more features of a road. Additionally or alternatively, parking prediction system 102 performs a smoothing process on the one or more feature maps based on receiving the one or more feature maps.

In the example above, parking prediction system 102 determines feature map data associated with an element of a matrix of the one or more feature maps. In some non-limiting embodiments, parking prediction system 102 determines feature map data associated with an element of a first feature map of the one or more feature maps and feature map data associated with an element of a second feature map of the one or more feature maps. In some non-limiting embodiments, the location of the element of the first feature map corresponds to the location of the element of the matrix of the second feature map. In some non-limiting embodiments, the coordinate of the element (e.g., the value of the row of the matrix, the value of the column of the matrix) of the first feature map corresponds to the coordinate of the element of the second feature map. In some non-limiting embodiments, the first feature map has a size that is the same as or different from the size of the second feature map. In some non-limiting embodiments, parking prediction system 102 determines feature map data associated with an element of a feature map (e.g., a first feature map) upon which a smoothing process has been performed and feature map data associated with an element of a feature map (e.g., a second feature map) upon which a smoothing process has not been performed.

Referring back to the example above, parking prediction system 102 provides the feature map data as an input to the decision tree model. In some non-limiting embodiments, parking prediction system 102 receives a prediction score associated with an element of the matrix of the one or more feature maps as an output of the decision tree model.

In some non-limiting embodiments, parking prediction system 102 generates a map (e.g., a vehicle map, a feature map, etc.) and/or map data associated with the map based on the prediction score generated by parking prediction system 102. For example, parking prediction system 102 generates the map based on a prediction score generated using a machine learning technique.

In some non-limiting embodiments, parking prediction system 102 generates an overlay that includes one or more prediction scores associated with one or more elements of a matrix of an image (e.g., a geographic location image, a vehicle map, a feature map, etc.) that was used to determine the one or more prediction scores. In some non-limiting embodiments, parking prediction system 102 generates a map by combining the overlay and the image that was used to determine the one or more prediction scores. In some non-limiting embodiments, parking prediction system 102 combines the overlay with the image that includes an area (e.g., a plurality of elements of a matrix of the image) labeled (e.g., labeled by an individual) as a parking location. For example, parking prediction system 102 combines the overlay with the image to generate an image that includes the one or more prediction scores in a plurality of elements that are labeled as a parking location.

In some non-limiting embodiments, parking prediction system 102 applies a post-processing image technique (e.g., spatial smoothing, thresholding, clustering, such as detecting connected components, creating convex hulls around a cluster, applying a minimum bounding box, merging areas in proximity to each other, rotating elements of the map, applying map constraints to the map, etc.) to the map.

In some non-limiting embodiments, parking prediction system 102 applies a bilateral filter to one or more elements of the map to perform spatial smoothing of the map. For example, parking prediction system 102 applies the bilateral filter and replaces the prediction score of an element with a weighted average of prediction scores associated with elements that are in proximity to the element upon which the bilateral filter was applied. In this way, parking prediction system 102 may allow for easier detection of a parking location in an image (e.g., a map) as compared to not applying a bilateral filter. Additionally, parking prediction system 102 may allow for easier detection of a parking location since the bilateral filter preserves sharp edges between a parking location and other features of a road. In some non-limiting embodiments, the weighted average is Gaussian-shaped based on a distance (e.g., a Euclidean distance) between the element upon which the bilateral filter was applied and the elements that are in proximity to the element.

In some embodiments, parking prediction system 102 converts a prediction score of an element of a map to an assigned value (e.g., a label) by comparing the prediction score to a threshold value of a prediction score. For example, parking prediction system 102 assigns a value (e.g., 1 or 0) to the element based on the prediction score of the element satisfying the threshold value.

In some non-limiting embodiments, parking prediction system 102 detects connected elements of the map to determine a parking location. For example, parking prediction system 102 determines one or more elements of the map that include map data that indicates the one or more elements are associated with (e.g., predicted to be, predicted to be part of, etc.) a parking location. Parking prediction system 102 determine one or more elements that are in proximity to (e.g., next to, adjacent, immediately above and/or below, immediately next to, immediately above and/or below and immediately next to but not in a diagonal relationship to, etc.) a first element (e.g., a first element of one or more elements) that includes map data that indicates the one or more elements are associated with (e.g., predicted to be, predicted to be part of, etc.) a parking location. If the one or more elements that are in proximity to the first element also includes map data that indicates the one or more elements are associated with a parking location, parking prediction system 102 labels the area including the one or more elements and the first element as a parking location. In some non-limiting embodiments, parking prediction system 102 compares the parking location to a threshold value of size for a parking location (e.g., a threshold value of a number of elements associated with a parking location) and if the parking location satisfies or does not satisfy the threshold value of size, parking prediction system 102 includes or does not include the parking location as a labeled parking location in the map.

In some non-limiting embodiments, parking prediction system 102 creates a polygon (e.g., a convex hull, a convex envelope, etc.) around one or more elements of the map. For example, parking prediction system 102 creates a polygon around a cluster of elements that include map data that indicates the one or more elements are associated with a parking location. The polygon represents the smallest convex set of elements that include one or more elements of the map that include map data that indicates the one or more elements are associated with a parking location.

In some non-limiting embodiments, parking prediction system 102 generates a bounding box (e.g., a minimum bounding box, a minimum boundary box, etc.) around a polygon and if the bounding box includes a dimension (e.g., a length dimension, a width dimension, etc.) that satisfies or does not satisfy a threshold value of the dimension, parking prediction system 102 includes or does not include a parking location encompassed by the bounding box as a labeled parking location in the map. Additionally or alternatively, if the he bounding box encompasses an area (e.g., an area made up of a plurality of elements) that satisfies or does not satisfy a threshold value of area, parking prediction system 102 includes or does not include the area encompassed by the bounding box as a labeled parking location in the map.

In some non-limiting embodiments, parking prediction system 102 rotates a bounding box. For example, parking prediction system 102 projects a bounding box in a direction towards a road edge that is in proximity to (e.g., adjacent, nearest to, etc.). Parking prediction system 102 rotates the bounding box so that bounding box aligns with the direction.

In some non-limiting embodiments, parking prediction system 102 combines or does not combine a first bounding box and a second bounding box based on a threshold value of distance (e.g., 1 m, 3, m, 5 m, an average length of a vehicle, etc.) between the first bounding box and the second bounding box. For example, if a distance between the first bounding box and the second bounding box satisfies or does not satisfy the threshold value of distance, parking prediction system 102 combines or does not combine the first bounding box and the second bounding box into a single bounding box and the single bounding box becomes a labeled parking location in the map.

In some non-limiting embodiments, parking prediction system 102 includes or does not include an area defined by a bounding box as a labeled parking location in the map based on whether the bounding box is consistent with feature map data associated with one or more features of a road. For example, parking prediction system 102 removes a bounding box or reduces a size of the area of a bounding box if the bounding box is determined to intersect with a road edge of a road, a lane of a roadway of a road, and/or the like.

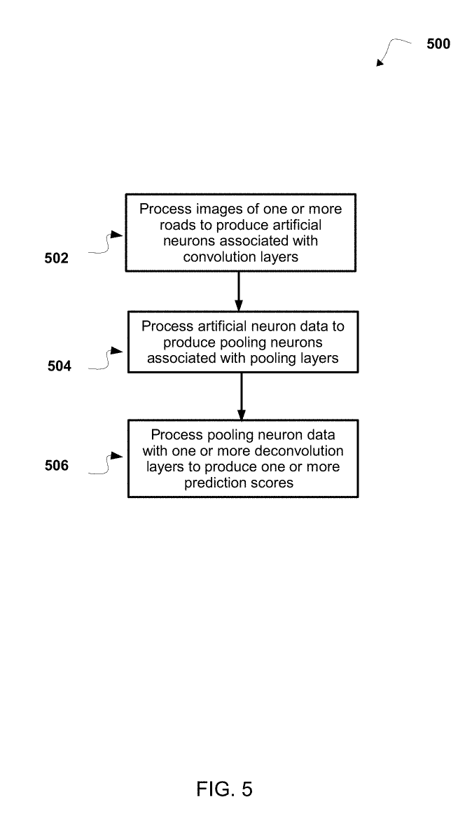

Further details regarding non-limiting embodiments of step 404 of process 400 are provided below with regard to FIG. 5.

As further shown in FIG. 4, at step 406, process 400 includes outputting image data based on the prediction score. For example, parking prediction system 102 outputs image data (e.g., vehicle map data, feature map data, etc.) associated with an image that was used to generate the predictions score after generating the prediction scores. In some non-limiting embodiments, parking prediction system 102 determines (e.g., generates) a prediction score for each element of a matrix of the image. For example, parking prediction system 102 determines a prediction score for each element of a feature map, a vehicle map, and/or a geographic location image. In some non-limiting embodiments, parking prediction system 102 generates an image that includes the prediction score of each element of the matrix of the image. For example, parking prediction system 102 generates a feature map, a vehicle map, and/or a geographic location image that includes the prediction score of each element of the feature map, the vehicle map, and/or the geographic location image.

In some non-limiting embodiments, parking prediction system 102 may generate a map (e.g., a vehicle map, an AV map, a feature map, etc.) based on the prediction score. For example, parking prediction system 102 generates a vehicle map and/or a feature map that includes the prediction score of each element of a matrix of the map (e.g., the vehicle map, the feature map, etc.). In some non-limiting embodiments, parking prediction system 102 generates a map based on the prediction score that includes additional image data associated with map. For example, parking prediction system 102 generates a new map, updates a previous map, and/or the like. In some non-limiting embodiments, parking prediction system 102 may generate the map so that the map includes a labeled parking location. For example, parking prediction system 102 may determine whether each element of the matrix of the vehicle map and/or the feature map includes a prediction score indicating that element is associated with a parking location. Parking prediction system 102 labels or does not label the one or more elements of the matrix of the vehicle map and/or the feature map as a labeled parking location based on determining that the one or more elements include or do not include a prediction score indicating that the one or more elements are associated with a parking location.

In some non-limiting embodiments, parking prediction system 102 outputs the map and/or map data associated with the map. For example, parking prediction system 102 outputs the map to autonomous vehicle 106 and the map includes the one or more prediction scores and/or one or more labeled parking locations. In some non-limiting embodiments, parking prediction system 102 outputs the map and/or the map data associated with the map to autonomous vehicle 106 based on generating the map. In some non-limiting embodiments, parking prediction system 102 outputs the map and/or the map data based on generating the prediction score.

In some non-limiting embodiments, parking prediction system 102 and/or autonomous vehicle 106 compare a prediction score of an element of the map to a threshold value of a prediction score. In some non-limiting embodiments, parking prediction system 102 and/or autonomous vehicle 106 determine that an element of the map includes a parking location based on the prediction score of an element of the map satisfying the threshold value of the prediction score.

In some non-limiting embodiments, parking prediction system 102 generates the map and parking prediction system 102 processes the map using a binary classifier. For example, parking prediction system 102 generates the map that includes one or more prediction scores associated with one or more elements of the map. Parking prediction system 102 processes the map so that the map includes one or more labeled parking locations. In some non-limiting embodiments, parking prediction system 102 uses a threshold value of a prediction score associated with the binary classifier to determine whether the one or more elements of the map include a parking location. For example, parking prediction system 102 compares the one or more prediction scores associated with one or more elements of the map to the threshold value of a prediction score. If the one or more prediction scores associated with the one or more elements satisfy or do not satisfy the threshold value, parking prediction system 102 labels or does not label the one or more elements as a parking location on the map.

In some non-limiting embodiments, parking prediction system 102 determines whether a labeled parking location is available to be used by a vehicle (e.g., autonomous vehicle 106) for parking the vehicle. For example, parking prediction system 102 determines that a labeled parking location is an available parking location (e.g., an parking location that not occupied by a vehicle, an unoccupied parking location, etc.) or is not an available parking location to be used by the vehicle for parking based on feature map data associated with a feature map that corresponds to the map. In some non-limiting embodiments, parking prediction system 102 compares a labeled parking location of a road to data associated with a turning lane of a roadway of the road and parking prediction system 102 determines that the labeled parking location is not an available parking location based on a distance between the labeled parking location and the turning lane of the roadway.

In some non-limiting embodiments, parking prediction system 102 determines a pickup location for an individual (e.g., a rider of autonomous vehicle 106), a drop-off location for an individual, and/or a location for an emergency stop of autonomous vehicle 106 based on a parking location (e.g., a parking location of a map). For example, parking prediction system 102 determines the pickup location for an individual and/or the drop-off location for the individual and parking prediction system 102 provides data associated with the pickup location for an individual and/or the drop-off location to the individual via an application (e.g., a mobile application) on a user device (e.g., a mobile phone, a smartphone, etc.) associated with the individual.

In some non-limiting embodiments, parking prediction system 102 provides the map to autonomous vehicle 106 and autonomous vehicle 106 travels (e.g., navigate, travels on a route, navigates a route, etc.) based on the map. For example, autonomous vehicle 106 receives one or more AV maps (e.g., one or more AV submaps) associated with a geographic location in which autonomous vehicle 106 operates, where the one or more AV maps are generated based on the map. In some non-limiting embodiments, the one or more AV maps include the map, the one or more AV maps include a parking location of a map, and the one or more AV maps include a labeled parking location that is determined by parking prediction system 102 based on a map, and/or the like. In some non-limiting embodiments, the autonomous vehicle 106 performs vehicle control actions (e.g., braking, steering, accelerating) and plans a route based on a parking location of the map. In some non-limiting embodiments, autonomous vehicle 106 determines a pickup location for an individual (e.g., a rider of autonomous vehicle 106), a drop-off location for an individual, and a location for an emergency stop of autonomous vehicle 106 based on a parking location of a map.

In some non-limiting embodiments, autonomous vehicle 106 travels to a parking location based on the map. For example, autonomous vehicle 106 travels to a parking location based on receiving an AV map associated with the map. In some non-limiting embodiments, autonomous vehicle 106 determines whether a parking location is an available parking location based on the map. Additionally or alternatively, autonomous vehicle 106 determines whether a parking location is not an available parking location based on the map. For example, autonomous vehicle 106 determines that the parking location is available based on an indication in an AV map that was generated based on the map.

In some non-limiting embodiments, autonomous vehicle 106 perform an action based on determining that a parking location is or is not available. For example, autonomous vehicle 106 identifies (e.g., identifies based on data received from sensors 206) whether one or more vehicles are located in a parking location based on autonomous vehicle 106 determining that a parking location is or is not available. In another example, autonomous vehicle 106 determines (e.g., determines based on data received from sensors 206) whether one or more vehicles, which have been determined to be located in a parking location, are traveling or are not traveling and autonomous vehicle 106 determine to perform an action based on determining the one more vehicles are or are not traveling.

In some non-limiting embodiments, autonomous vehicle 106 travels to a parking location and parks in the parking location based on determining that a parking location is or is not available. For example, autonomous vehicle 106 travels to a parking location prior to an estimated time of arrival (e.g., an estimated time of arrival of a rider, an estimated time of arrival of autonomous vehicle 106 provided to a rider, etc.) and parks in the parking location based on determining that a parking location is or is not available.

In some non-limiting embodiments, autonomous vehicle 106 travels to a parking location and performs an action based on feature map data associated with associated with one or more features of a road (e.g., a road in which the parking location is located). For example, autonomous vehicle 106 parks or does not park in the parking location based on determining data associated with an object (e.g., a size of a vehicle) located in the parking location.

In some non-limiting embodiments, autonomous vehicle 106 travels on a route (e.g., a route to a parking location) and determines whether to stay in a location (e.g., to queue) behind a vehicle that is stopped or to travel past (e.g., to travel around, to pass, etc.) the vehicle. For example, autonomous vehicle 106 determines that the vehicle is stopped in a location that is not a parking location based on the map. In such an example, autonomous vehicle determines to stay in a location behind the vehicle or to travel past the vehicle based on determining that the vehicle is stopped in a location that is not a parking location. In another example, autonomous vehicle 106 determines that the vehicle is stopped in a location that is a parking location based on the map. In such an example, autonomous vehicle 106 determines to stay in a location behind the vehicle or to travel past the vehicle based on determining that the vehicle is stopped in a location that is a parking location.

In some non-limiting embodiments, autonomous vehicle 106 detects an object that is hazardous based on a map. For example, the autonomous vehicle 106 detects an object (e.g. a vehicle, a bicyclists, a pedestrian, an objects in proximity to or within the road, etc.) that is stopped or that is traveling based on a proximity of the object to a parking location of the map.

In some non-limiting embodiments, autonomous vehicle 106 changes a direction (e.g., change from a route to an alternate route, etc.) that autonomous vehicle 106 is traveling based on the map. For example, autonomous vehicle 106 determines that a vehicle is stopped (e.g., parked) in a parking location of the map. Autonomous vehicle 106 determines to travel to another parking location of the map based on determining that a vehicle is stopped in the parking location.

Referring now to FIG. 5, FIG. 5 is a flowchart of a non-limiting embodiment of a process 500 for using a convolutional neural network model to generate one or more prediction scores associated with one or more elements of a matrix of one or more images that are used as inputs to the convolutional neural network model. By using a convolutional neural network model to generate the one or more prediction scores, parking prediction system 102 conserves processing resources as compared to using other machine learning techniques, such as a decision tree model, since parking prediction system 102 may be required to determine manual descriptions of aspects of the one or more images that are used as inputs to decision tree model.

In some non-limiting embodiments, one or more of the steps of process 500 can be performed (e.g., completely, partially, etc.) by parking prediction system 102 (e.g., one or more devices of parking prediction system 102). In some non-limiting embodiments, one or more of the steps of process 500 can be performed (e.g., completely, partially, etc.) by another device or a group of devices separate from or including parking prediction system 102, such as image database 104 (e.g., one or more devices of image database 104), or autonomous vehicle 106 (e.g., one or more devices of autonomous vehicle 106).

As shown in FIG. 5, at step 502, process 500 includes processing one or more images (e.g., one or more feature maps, one or more vehicle maps, one or more geographic location images, etc.) of one or more roads to produce one or more artificial neurons associated with one or more convolution layers of a convolutional neural network model. For example, parking prediction system 102 processes the one or more images using a scanning window to produce one or more artificial neurons associated with one or more convolution layers (e.g., 1 convolution layer, 5 convolution layers, etc.) of a convolutional neural network model. In some non-limiting embodiments, the one or more convolution layers include a plurality of artificial neurons associated with artificial neuron data.

In some non-limiting embodiments, the one or more images includes a stack of a plurality of images. For example, the stack (e.g., a vertically oriented stack, a horizontally oriented stack, etc.) of the plurality of images may be arranged so that the elements of a matrix of each of the images are aligned (e.g., a location of a first element of a first image in a first matrix is the same as a location of a second element of a second image in a second matrix).

In some non-limiting embodiments, parking prediction system 102 scans (e.g., scans simultaneously, scans contemporaneously, scans sequentially, scans in parallel, etc.) the one or more images with a filter associated with the one or more convolution layers to produce artificial neuron data associated with one or more artificial neurons of a convolution layer. For example, parking prediction system 102 scans the one or more elements of the matrix of the one or more images with a filter and parking prediction system 102 produces the artificial neuron data by combining one or more values (e.g., a weight, a bias term, a value of feature map data, etc.) associated with an element of the one or more elements with one or more values associated with another element of the one or more elements. In some non-limiting embodiments, the filter comprises a scanning window having a predetermined size (e.g., a kernel size, a size corresponding to size of a number of elements, 1 element by 1 element, 2 elements by 2 elements, 3 elements by 3 elements, 5 elements by 5 elements, 6 elements by 6 elements, etc.) that determines how many elements, the one or more values of which, are combined. In some non-limiting embodiments, the artificial neuron data corresponds to (e.g., corresponds in size to, corresponds based on an area encompassed by, correspond based on a location encompassed by, etc.) the predetermined size of the scanning window. For example, the artificial neuron data is produced based on combining a number of elements included in the scanning window and the number of elements included in the scanning window is based on the predetermined size of the scanning window.

In some non-limiting embodiments, parking prediction system 102 scans (e.g., scans simultaneously, scans contemporaneously, scans sequentially, scans in parallel, etc.) a stack of a plurality of images. For example, parking prediction system 102 scans an element of a matrix of a first image of the plurality of images in the stack and parking prediction system 102 scans an element of a matrix of a second image of the plurality of images in the stack that is aligned with the element of the matrix of the first image. In some non-limiting embodiments, parking prediction system 102 scans (e.g., scans simultaneously, scans contemporaneously, scans sequentially, scans in parallel, etc.) the stack of the plurality of images. For example, parking prediction system 102 scans each image of the stack of images in three dimensions.

As further shown in FIG. 5, at step 504, process 500 includes processing artificial neuron data associated with the one or more convolution layers to produce one or more pooling neurons associated with one or more pooling layers of the convolutional neural network model. For example, parking prediction system 102 processes artificial neuron data associated with one or more convolution layers of the convolution neural network to produce one or more pooling neurons associated with one or more pooling layers (e.g., 1 pooling layer, 3 pooling layers, etc.) of the convolution neural network.

In some non-limiting embodiments, parking prediction system 102 scans (e.g., subsamples, scans simultaneously, scans contemporaneously, scans sequentially, scans in parallel, etc.) the one or more convolution layers with a filter associated with the one or more pooling layers to produce pooling neuron data associated with one or more pooling neurons of a pooling layer. For example, parking prediction system 102 scans (e.g., scans simultaneously, scans contemporaneously, scans sequentially, scans in parallel, etc.) the one or more convolution layers with a filter and parking prediction system 102 produces the pooling neuron data by aggregating (e.g., averaging, determining a maximum, determining a mean, etc.) a plurality of values associated with a plurality of artificial neurons of the one or more convolution layers. In some non-limiting embodiments, parking prediction system 102 determines a maximum value of the values associated with the plurality of artificial neurons and discards all other values that are not the maximum value. In some non-limiting embodiments, the filter includes a scanning window having a predetermined size (e.g., a kernel size, a size corresponding to size of a number of elements, 1 element by 1 element, 2 elements by 2 elements, 3 elements by 3 elements, 5 elements by 5 elements, 6 elements by 6 elements, etc.) that determines how many artificial neurons, the values of which, are aggregated.

As further shown in FIG. 5, at step 506, process 500 includes processing the pooling neuron data associated with the one or more pooling neurons of the one or more pooling layers with one or more deconvolution layers (e.g., one or more transposed convolution layers, one or more reverse convolution layers, etc.) of the convolutional neural network model to produce one or more prediction scores. For example, parking prediction system 102 processes the pooling neuron data associated with the one or more pooling neurons of the one or more pooling layers with one or more deconvolution layers of the convolutional neural network model to produce one or more prediction scores.

In some non-limiting embodiments, parking prediction system 102 upsamples (e.g., transposes, interpolates, etc.) the one or more pooling neurons and parking prediction system 102 produces an image (e.g., an output image, a feature map, a vehicle map, a geographic location image, etc.) that includes one or more prediction scores associated with one or more elements (e.g., an area made up of one or more elements) of the image. For example, parking prediction system 102 uses a filter associated with the one or more deconvolution layers to upsample (e.g., transpose, interpolate, etc.) the pooling neuron data associated with one or more pooling neurons to produce the output image. In some non-limiting embodiments, the filter includes a scanning window having a predetermined size (e.g., a kernel size, a size corresponding to size of a number of elements, etc.) that determines how many elements (e.g., how many elements in an output) are produced using the filter. In some non-limiting embodiments, the filter associated with the one or more deconvolution layers is the same or similar as a filter associated with one or more convolution layers.

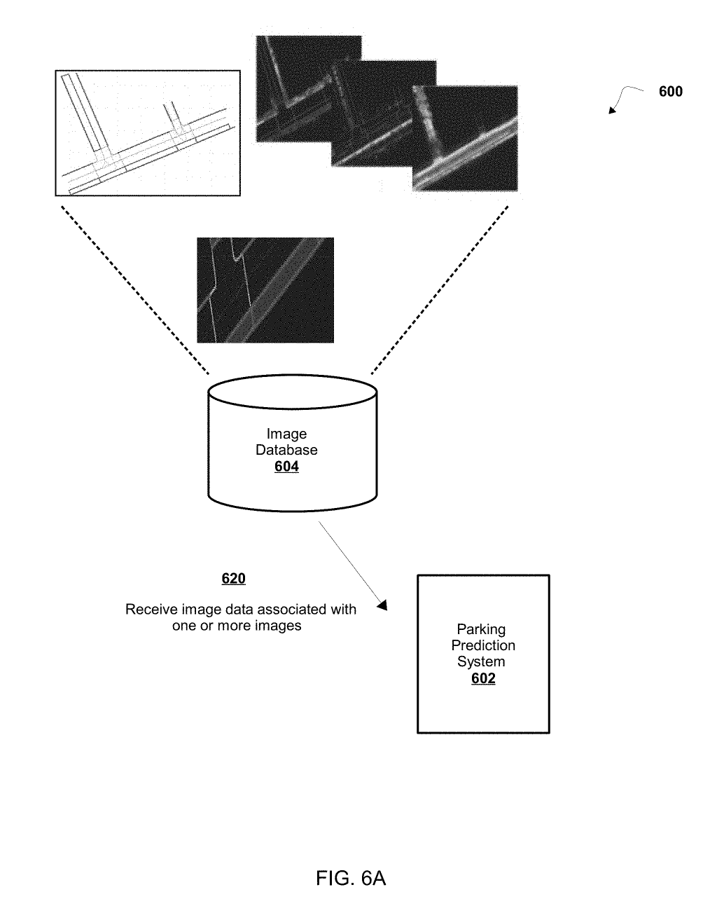

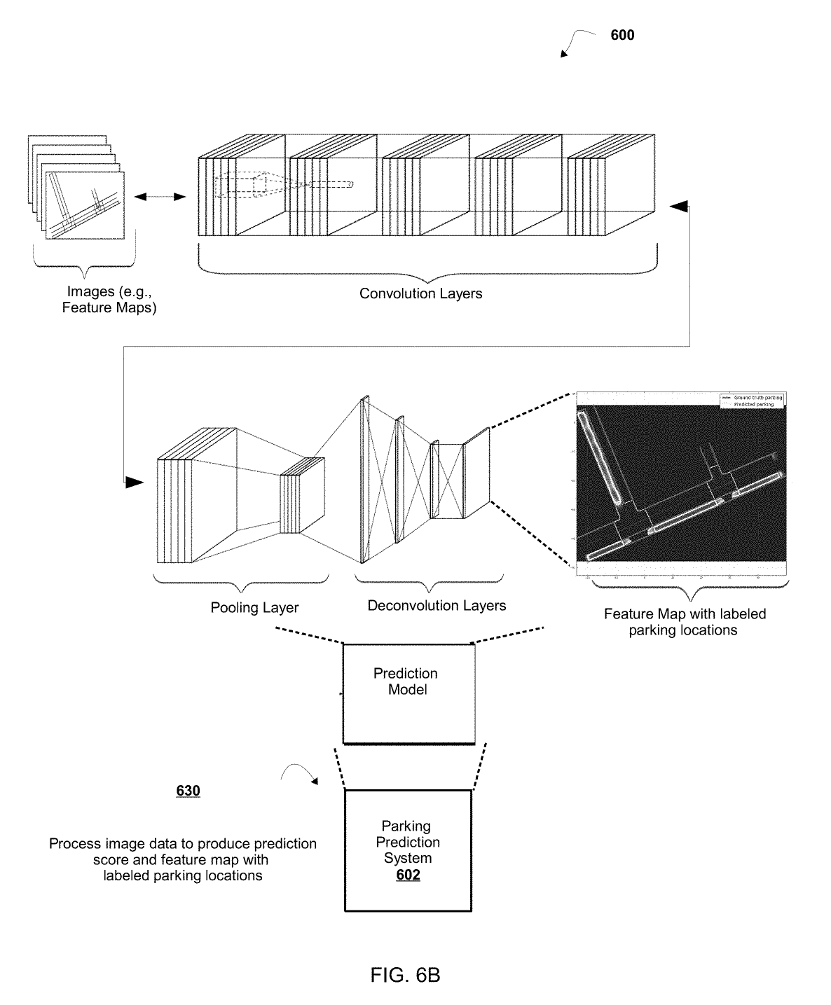

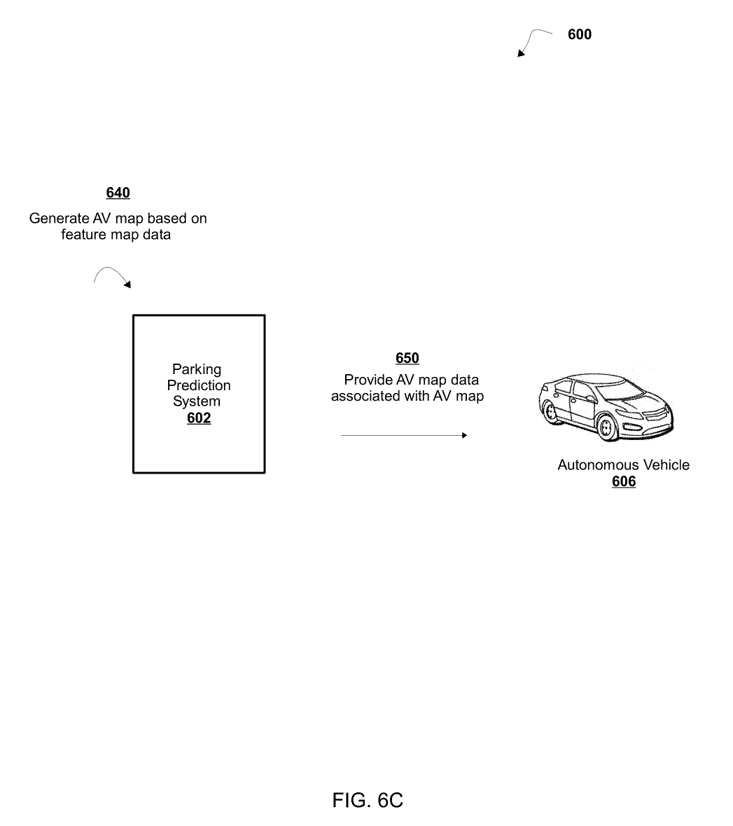

Referring now to FIGS. 6A-6C, FIGS. 6A-6C are diagrams of an overview of a non-limiting embodiment of an implementation 600 relating to a process for predicting parking locations based on image data. As shown in FIGS. 6A-6C, implementation 600 includes parking prediction system 602, image database 604, and autonomous vehicle 606. In some non-limiting embodiments, parking prediction system 602 can be the same or similar to parking prediction system 102. In some non-limiting embodiments, image database 604 can be the same or similar to image database 104. In some non-limiting embodiments, autonomous vehicle 606 can be the same or similar to autonomous vehicle 106.

As shown by reference number 620 in FIG. 6A, parking prediction system 602 receives image data associated with one or more images (e.g., one or more feature maps, etc.) from image database 604. As shown by reference number 630 in FIG. 6B, parking prediction system 602 processes the image data associated with the one or more images to generate a prediction score for each element of a matrix of the image and to produce a feature map that includes labeled parking locations. For example, prediction system 602 processes the image data using a prediction model that includes a convolutional neural network to generate a prediction score for each element of the matrix of the image. Parking prediction system 602 generates a feature map based on the prediction score of each element of the matrix of the image and the feature map includes labeled parking locations. In some non-limiting embodiments, parking prediction system 602 labels the labeled parking locations based on the prediction score of each element of the matrix within the area of the feature map associated with labeled parking location.

As shown by reference number 640 in FIG. 6C, parking prediction system 602 generates an AV map based on feature map data associated with the feature map. As further shown by reference number 650 in FIG. 6C, parking prediction system 602 provide AV map data associated with the AV map to autonomous vehicle 606. In some non-limiting embodiments, autonomous vehicle 606 may travel to the labeled parking location based on receiving the AV map data associated with the AV map.

The foregoing disclosure provides illustration and description, but is not intended to be exhaustive or to limit the implementations to the precise form disclosed. Modifications and variations are possible in light of the above disclosure or can be acquired from practice of the implementations.

Some implementations are described herein in connection with thresholds. As used herein, satisfying a threshold refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features be combined in ways not specifically recited in the claims and/or disclosed in the specification. Although each dependent claim listed below can directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and can be used interchangeably with “one or more” and/or “at least one”. Furthermore, as used herein, the term “set” is intended to include one or more items (e.g., related items, unrelated items, a combination of related and unrelated items, etc.), and can be used interchangeably with “one or more” and/or “at least one.” Where only one item is intended, the term “one” or similar language is used. Also, as used herein, the terms “has,” “have,” “having,” and/or the like are intended to be open-ended terms. Further, the phrase “based on” is intended to mean “based, at least in part, on,” “in response to,” and/or the like, unless explicitly stated otherwise.

What is claimed is:

1. A method, comprising:
receiving, with a computer system comprising one or more processors, feature map data associated with a feature map, wherein the feature map comprises a plurality of elements of a matrix, wherein one or more elements of the matrix comprises the feature map data, wherein the feature map data is associated with one or more features of a road;
processing, with the computer system, the feature map data to produce artificial neuron data associated with one or more artificial neurons of one or more convolution layers;
generating, with the computer system, a prediction score for the one or more elements of the feature map based on the artificial neuron data, wherein the prediction score comprises a prediction of whether an element of a feature map comprises a parking location; and
outputting, with the computer system, map data associated with a map, wherein the map data is based on the one or more prediction scores associated with the one or more elements of the feature map.

2. The method of claim 1, further comprising:
processing, with the computer system, the artificial neuron data associated with one or more artificial neurons of the one or more convolution layers to produce pooling neuron data associated with one or more pooling neurons of a pooling layer; and
wherein generating the prediction score for the one or more elements of the feature map comprises:
generating, with the computer system, the prediction score for the one or more elements of the feature map based on the artificial neuron data and the pooling neuron data.

3. The method of claim 2, wherein generating the prediction score for the one or more elements of the feature map comprises:
processing, with the computer system, the pooling neuron data with one or more deconvolution layers to produce the prediction score.

4. The method of claim 2, wherein processing the artificial neuron data comprises:
combining, with the computer system, first artificial neuron data associated with a first artificial neuron in the one or more convolution layers and second artificial neuron data associated with a second artificial neuron in the one or more convolution layers to produce the pooling neuron data associated with the one or more pooling neurons of the pooling layer.

5. The method of claim 1, wherein the one or more elements of the feature map comprise one or more first elements of the feature map, the method further comprising:
determining, with the computer system, a weighted average for the one or more first elements of the feature map, wherein the weighted average is determined based on a prediction score of one or more second elements of the feature map that are in proximity to the one or more first elements of the feature map; and
wherein the method further comprises:
determining, with the computer system, the map data associated with the map based on the weighted average for the one or more first elements of the feature map.

6. The method of claim 1, wherein processing the feature map data comprises:
scanning, with the computer system, the plurality of elements of the matrix of the feature map with a filter, the filter comprising a scanning window having a predetermined size; and
producing, with the computer system, the artificial neuron data by combining weights of the plurality of elements of the matrix of the feature map with the filter, the artificial neuron data corresponding to the predetermined size of the scanning window.

7. The method of claim 1, further comprising:
determining, with the computer system, whether the one or more elements of the feature map comprise the parking location based on the prediction score of the one or more elements of the feature map; and
wherein the parking location comprises a segment of a parking lane of a roadway of the road.

8. A computing system, comprising:
one or more processors programmed or configured to:
receive a plurality of feature maps, wherein each feature map of the plurality of feature maps comprises a plurality of elements of a matrix, wherein each element of the matrix comprises feature map data, wherein the feature map data is associated with one or more features of a road;
process the feature map data associated with the plurality of feature maps to produce artificial neuron data associated with a plurality of artificial neurons of a plurality of convolution layers;
generate a prediction score for one or more elements of the matrix of each feature map of the plurality of feature maps based on the artificial neuron data, wherein the prediction score comprises a prediction of whether an element of a feature map comprises a parking location;
determine whether one or more elements of the matrix of each feature map of the plurality of feature maps comprises the parking location based on the prediction score of the one or more elements of the matrix of each feature map; and
output map data associated with a map based on determining that the one or more elements of the matrix of each feature map comprises the parking location.

9. The computing system of claim 8, wherein the one or more processors are further programmed or configured to:
process the artificial neuron data associated with one or more artificial neurons of the plurality of convolution layers to produce pooling neuron data associated with one or more pooling neurons of a pooling layer; and
wherein the one or more processors, when generating the prediction score for the one or more elements of each feature map, is to:
generate the prediction score for the one or more elements of each feature map based on the artificial neuron data and the pooling neuron data.

10. The computing system of claim 9, wherein the one or more processors, when generating the prediction score for the one or more elements of each feature map, are programmed or configured to:
process the pooling neuron data with one or more deconvolution layers to produce the prediction score.

11. The computing system of claim 9, wherein the one or more processors, when processing the artificial neuron data, are programmed or configured to:
combine first artificial neuron data associated with a first artificial neuron in a first convolution layer of the plurality of convolution layers and second artificial neuron data associated with a second artificial neuron in the first convolution layer to produce the pooling neuron data.

12. The computing system of claim 8, wherein the one or more processors are further programmed or configured to:
determine a weighted average for a plurality of first elements of a first feature map of the plurality of feature maps, wherein the weighted average is determined based on a prediction score of each element of a plurality of second elements of the first feature map that are in proximity to the plurality of first elements of the first feature map; and
wherein the one or more processors are further to:
determine the map data associated with the map based on the weighted average of the plurality of first elements of the first feature map.

13. The computing system of claim 8, wherein the one or more processors, when processing the feature map data, are programmed or configured to:
scan the plurality of elements of the matrix of each feature map with a filter, the filter comprising a scanning window having a predetermined size; and
produce the artificial neuron data by combining weights of the plurality of elements of the matrix of each feature map with the filter, the artificial neuron data corresponding to the predetermined size of the scanning window.

14. The computing system of claim 8, wherein the one or more processors, when outputting the map data associated with the map, are programmed or configured to:
output the map data associated with the map that includes a labeled parking location associated with the parking location; and
wherein the labeled parking location comprises a segment of a parking lane of a roadway of the road.

15. An autonomous vehicle, comprising:
one or more sensors for detecting an object in an environment surrounding the autonomous vehicle; and
a vehicle computing system comprising one or more processors, wherein the vehicle computing system is programmed or configured to:
receive autonomous vehicle (AV) map data associated with an AV map including one or more roads, the AV map including one or more prediction scores associated with one or more areas of the AV map, wherein the AV map data is determined based on:
receiving feature map data associated with a feature map, wherein the feature map comprises a plurality of elements of a matrix, wherein each element of the matrix comprises the feature map data, wherein the feature map data is associated with one or more features of a road,
processing the feature map data to produce artificial neuron data associated with one or more artificial neurons of one or more convolution layers,
generating a prediction score for each element of the feature map based on the artificial neuron data, wherein the one or more prediction scores are associated with a prediction of whether each element of the feature map comprises a parking location, and
determining the AV map data based on generating the one or more prediction scores for each element of the feature map; and
control travel of the autonomous vehicle based on sensor data from the one or more sensors and the AV map data associated with the AV map.

16. The autonomous vehicle of claim 15, wherein the vehicle computing system is further programmed or configured to:
determine that the one or more areas of the AV map comprise the parking location; and
cause the autonomous vehicle to travel with respect to the parking location based on determining that the one or more areas of the AV map comprise the parking location.

17. The autonomous vehicle of claim 15, wherein the vehicle computing system is further programmed or configured to:
determine that the one or more areas of the AV map comprise the parking location;
determine that another vehicle is located within the parking location based on the sensor data; and
control the autonomous vehicle to travel with respect to the parking location based on determining that the another vehicle is located within the parking location.

18. The autonomous vehicle of claim 15, wherein the parking location comprises a segment of a parking lane of a roadway of the road.

19. The autonomous vehicle of claim 15, wherein the vehicle computing system is further programmed or configured to:
determine that the one or more areas of the AV map comprise a feature of the one or more roads; and
cause the autonomous vehicle to travel with respect to the parking location based on determining that the one or more areas of the AV map comprise the feature of the one or more roads.

20. The autonomous vehicle of claim 15, wherein the vehicle computing system is further programmed or configured to:
determine a pickup location for an individual based on the parking location; and
cause the autonomous vehicle to travel with respect to the parking location based on determining the pickup location for the individual.
